(19) United States
(12) Patent Application Publication
(10) Pub. No.: US 2007/0294325 A1
(43) Pub. Date: Dec. 20, 2007

(54) Activity history record apparatus and method

(75) Inventors: Masakazu Fujimoto, Kanagawa (JP); Atsushi Ito, Kanagawa (JP); Yuichi Ueno, Kanagawa (JP); Yasuaki Konishi, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 11/598,110

(22) Filed: Nov. 13, 2006

(30) Foreign Application Priority Data
Jun. 19, 2006 (JP) 2006-168990

(51) Int. Cl. G06F 17/30

(52) U.S. Cl. 707/205

(57) ABSTRACT

An activity history record apparatus includes a portable receiver that receives information, which contains position information and which is transmitted from a transmitter disposed at a predetermined position. The receiver includes a reception section, a voice detection section and a storage section. The reception section receives the information. The voice detection section detects voice. The storage section stores the position information extracted from the received information and voice-related information derived from the voice detected by the voice detection section, as a history.

### BACKGROUND

### Technical Field

This invention relates to recording of an activity history.

### SUMMARY

According to an aspect of the invention, an activity history record apparatus includes a portable receiver that receives information, which contains position information and which is transmitted from a transmitter disposed at a predetermined position. The receiver includes a reception section, a voice detection section and a storage section. The reception section receives the information. The voice detection section detects voice. The storage section stores the position information extracted from the received information and voice-related information derived from the voice detected by the voice detection section, as a history.

### BRIEF DESCRIPTION OF THE DRAWINGS

Exemplary embodiments will be described in detail below with reference wherein:

FIG. 1 is a drawing to describe the related art;

FIG. 2 is a block diagram to show the configuration of a first exemplary embodiment of the invention;

FIG. 3 is a drawing to describe a use example of the first exemplary embodiment of the invention;

FIG. 4 is a flowchart to describe a processing example of a transmitter of the first exemplary embodiment of the invention;

FIG. 5 is a flowchart to describe a processing example of a receiver of the first exemplary embodiment of the invention;

FIG. 6 is a flowchart to describe a processing example of an analyzer of the first exemplary embodiment of the invention;

FIG. 7 is a flowchart to describe an example of speech determination processing of the first exemplary embodiment of the invention;

FIG. 8 is a drawing to describe an example of a data record structure of the first exemplary embodiment of the invention;

FIG. 9 is a drawing to describe an example of history analysis of the first exemplary embodiment of the invention;

FIG. 10 is a block diagram to show the configuration of a second exemplary embodiment of the invention;

FIG. 11 is a flowchart to describe a processing example of a receiver of the second exemplary embodiment of the invention;

FIG. 12 is a drawing to describe an example of a data record structure of the second exemplary embodiment of the invention;

FIG. 13 is a drawing to describe another example of the data record structure of the second exemplary embodiment of the invention;

FIG. 14 is a drawing to describe an example of history analysis of the second exemplary embodiment of the invention;

FIG. 15 is a flowchart to describe another processing example of history analysis of the invention; and

FIG. 16 shows an example of a diagram generated from the example in FIG. 15.

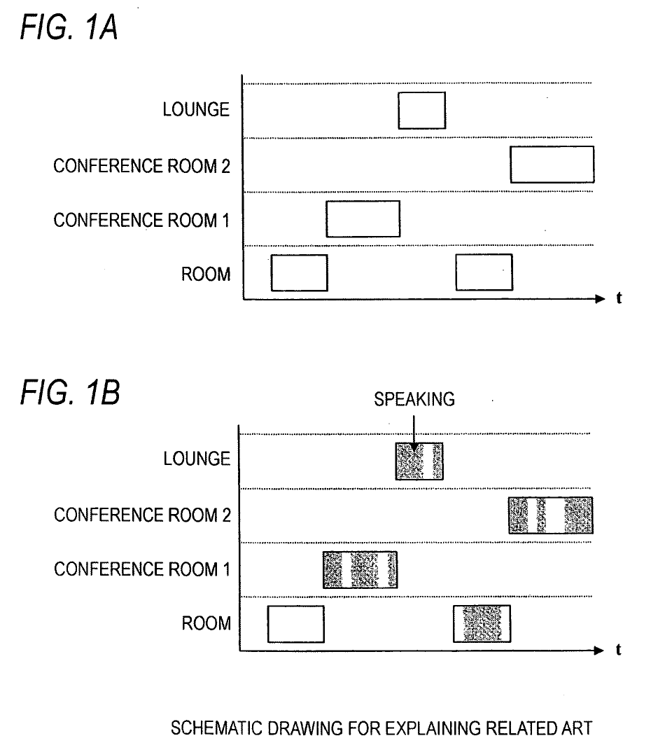

### DETAILED DESCRIPTION

Exemplary embodiments will be described below.

### First Exemplary Embodiment

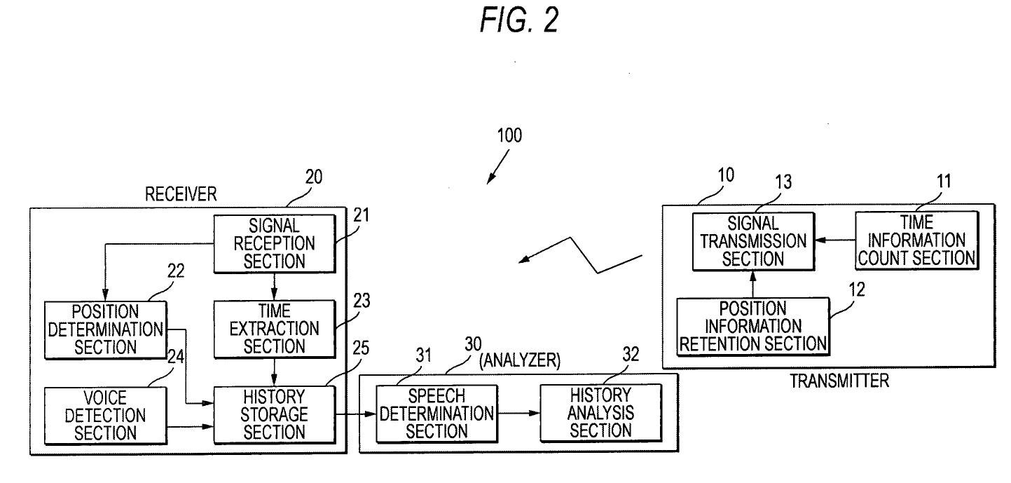

FIG. 2 shows the configuration of an activity history record system 100 according to a first exemplary embodiment of the invention. In the figure, only one transmitter 10 and only one receiver 20 are shown, but the transmitter 10 is provided at each of detection target positions (conference room, lounge, and room, which may be called as “venues” in the wide sense), and usually plural receivers 20 are provided because each detection target user carries the receiver 20.

In FIG. 2, the activity history record system 100 includes the transmitter 10, the receiver 20 and an analyzer 30.

The transmitter 10 includes a time information count section 11, a position information retention section 12 and a signal transmission section 13. The time information count section 11 counts the current time and outputs time information. Since it is just required to have time information, not only a method of counting the current time with a real time clock, but also a mechanism for obtaining external time information, such as a wave clock may be used. The position information retention section 12 retains position information about a position where the transmitter 10 is placed, for example, an ID. The signal transmission section 13 transmits the time information and the position information at the necessary timing using a wireless communication mechanism of radio wave, infrared radiation, etc.

The receiver 20 includes a signal reception section 21, a position determination section 22, a time extraction section 23, a voice detection section 24 and a history storage section 25. The signal reception section 21 receives a signal from the transmitter 10 and inputs the time information and the position information. The position determination section 22 extracts ID information indicating a position. The time extraction section 23 extracts the time information. The voice detection section 24 detects sound, such as a microphone or bone conduction, and may incorporate a frequency filter and a noise canceller. The history storage section 25 stores a set of the time information, the position information and the voice detection result as a history.

The analyzer 30 includes a speech determination section 31 and a history analysis section 32. The speech determination section 31 determines whether or not a user is speaking based on voice level information. In this example, the speech determination section 31 can be separated from the receiver 20, but may be integrated with the receiver 20. The history analysis section 32 analyzes the stored history. In this example, the history analysis section 32 can be separated from the receiver 20, but may be integrated with the receiver 20.

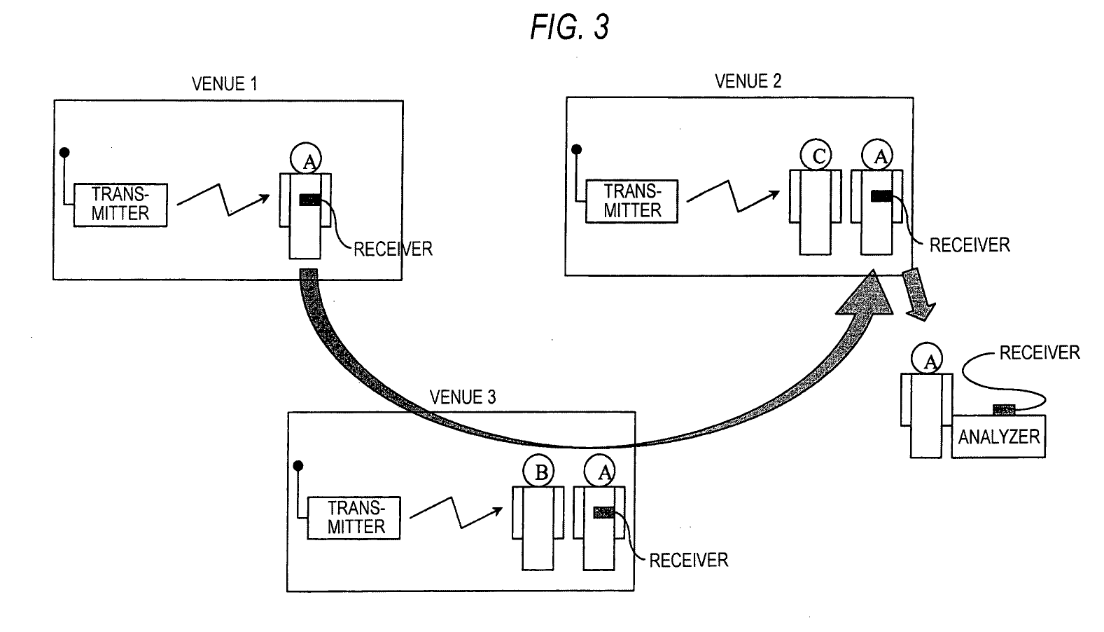

FIG. 3 describes a usage mode of the activity history record system 100 shown in FIG. 2. In the usage mode, users A, B and C carry proper receivers 20, and proper transmitters 10 are installed in venues 1 to 3. The users A, B, and C come and go to the venues 1 to 3 for activities, and a history of the activities is recorded in the carried receivers 20. Each user connects the receiver 20 to the analyzer 30 and sends history information to the analyzer 30 for conducting an analysis.

Plural analyzers 30 may be provided and connected through a communication network so that a server computer further analyzes the tallying result for use. The analyzer 30 may be a terminal such as a personal computer used by the user.

Next, the operation of the activity history record system 100 according to the exemplary embodiment will be described.

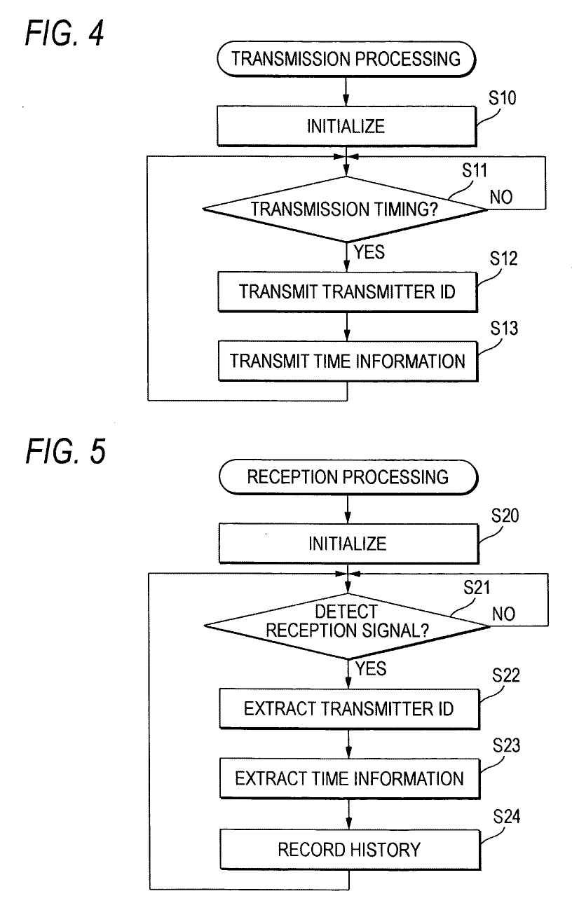

FIG. 4 shows the operation of the transmitter 10. In FIG. 4, first, initialization is executed (S10) and then, whether or not the timing is transmission timing is checked and the transmitter 10 waits until the transmission timing (S11). When the transmission timing comes, an ID unique to the transmitter 10 is transmitted and the time information is transmitted (S12 and S13). When the transmission is completed, the process returns to S11 (transmission timing check).

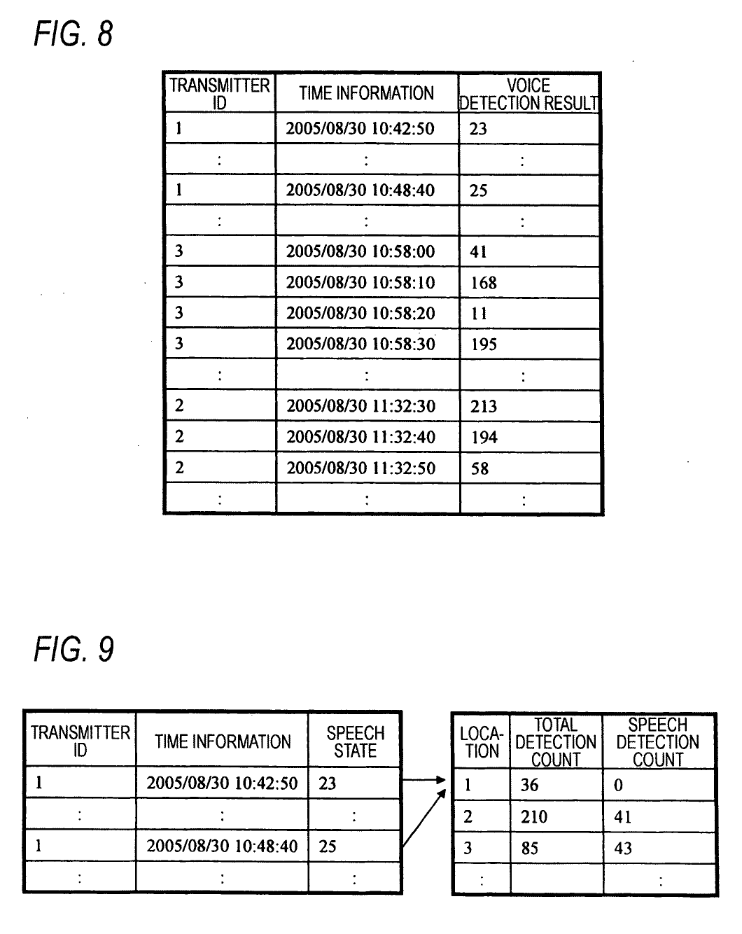

FIG. 5 shows the operation of the receiver 20. In FIG. 5, initialization is executed (S20) and then, the receiver 20 waits until detecting a reception signal (S21). When a reception signal is detected, the ID of the transmitter 10 is extracted from the reception signal and subsequently the timing information is extracted from the reception signal (S22 and S23). Then, the ID of the transmitter 10, the time information, and the voice detection result (volume level) are recorded and the process returns to S22 (reception signal detection check). In this example, the structure of the record data is one as shown in FIG. 8.

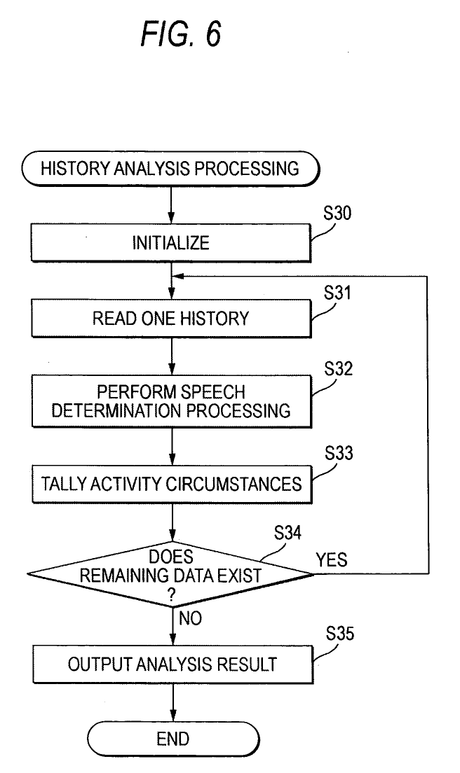

FIG. 6 shows the operation of the analyzer 30. Here, an example of tallying the activities of the receiver carriers is shown as a simple example of history analysis processing. In FIG. 6, when history analysis processing is started, initialization, such as generating a tallying table, is executed (S30). Next, an individual history is read, and it is determined whether or not the read individual history is in a speech state (S31 and S32). The numbers of times each transmitter ID is detected are tallied while being classified into the speech state and a non-speech state (S33). The tallying processing is continued until the all history data are processed, and when the all history data are processed, the tallying result is output and the processing is completed (S34 and S35).

FIG. 9 schematically shows an example where speech determination is made for each history, tallying is performed and the result is shown. In this example, the number of time speech is made in each location (transmitter ID) can be obtained, and where conversations are often held can be determined.

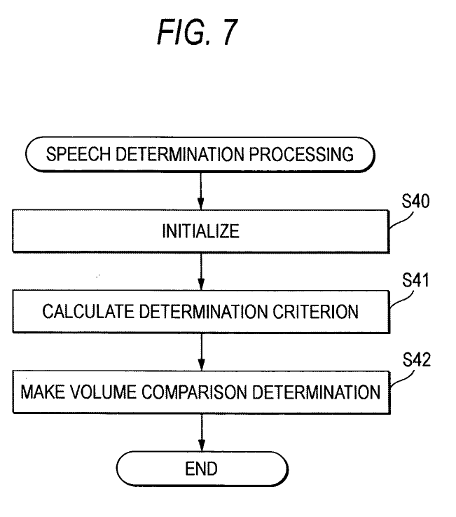

FIG. 7 shows an example of the speech determination processing by the analyzer 30 (S32). In FIG. 7, first, initialization is executed (S40). Next, a determination criterion value is calculated (S41). The determination criterion value can also be a predetermined fixed value. Volume data retained so far can be averaged to produce the determination criterion value. In this case, it is necessary to leave data of the average value and the number of pieces of reception data. For the average value and the number of data pieces, the average value can be updated according to the following expression:

(Average value)=(previous average value)+[(volume)−(previous average value)]/[(number of data pieces)+1]

Subsequently, whether or not speech occurs at the current volume level is determined and the result is returned (S42). It may be hard to determine whether or not speech occurs based on a given criterion value depending on the location (noisy location). Then, to avoid a noisy location, technology of a noise canceller may be used. Using position information, the determination criterion value may be varied from one location to another.

### Second Exemplary Embodiment

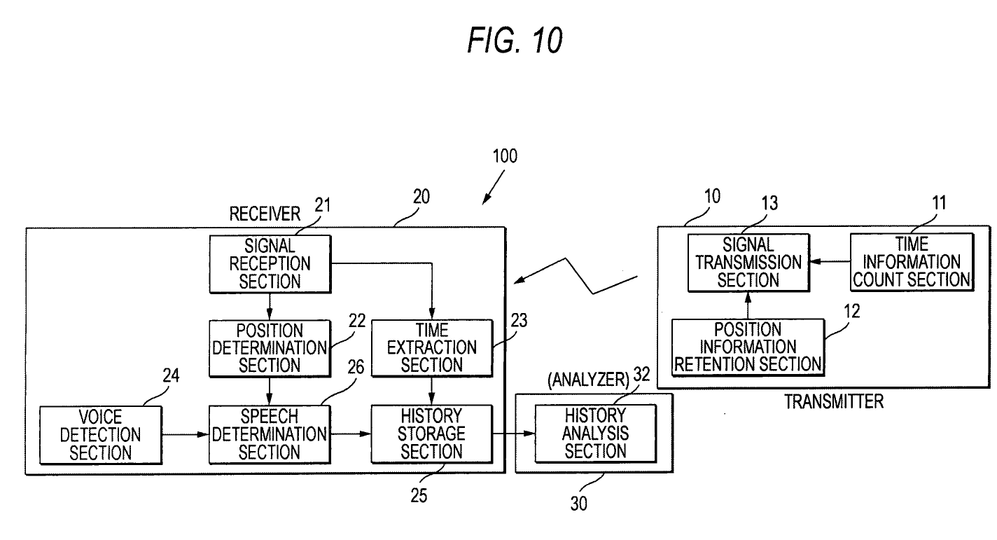

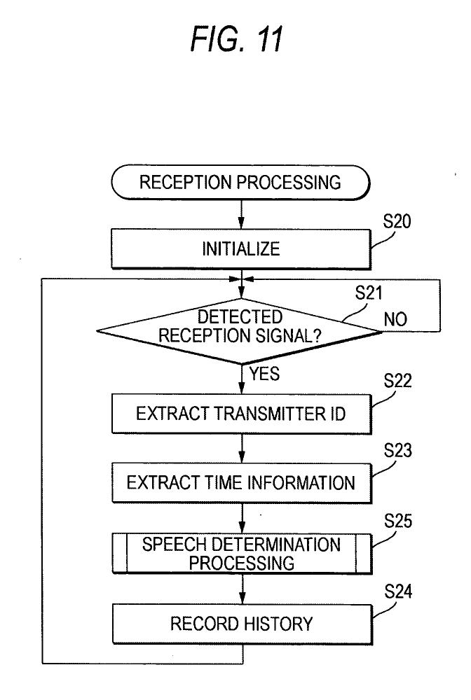

Next, an activity history record system according a second exemplary embodiment of the invention will be described. In the activity history record system of the second exemplary embodiment, a receiver 20 is provided with a speech determination section 26. Accordingly, an analyzer 30 is not provided with the speech determination section 31. FIG. 10 shows the configuration of the activity history record system of the second exemplary embodiment as a whole. Parts identical with or similar to those in FIG. 2 are denoted by the same reference numerals in FIG. 10. After extracting the transmitter ID and the time information, the receiver 20 performs speech determination processing (step S25) as shown in FIG. 11. The speech determination processing basically is similar to the processing shown in FIG. 7.

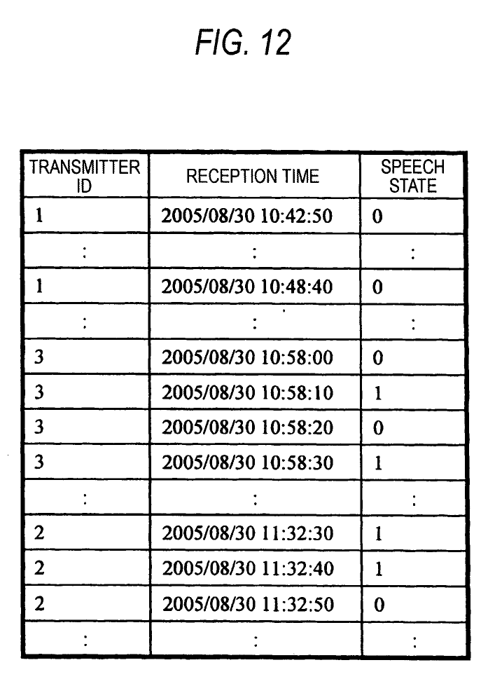

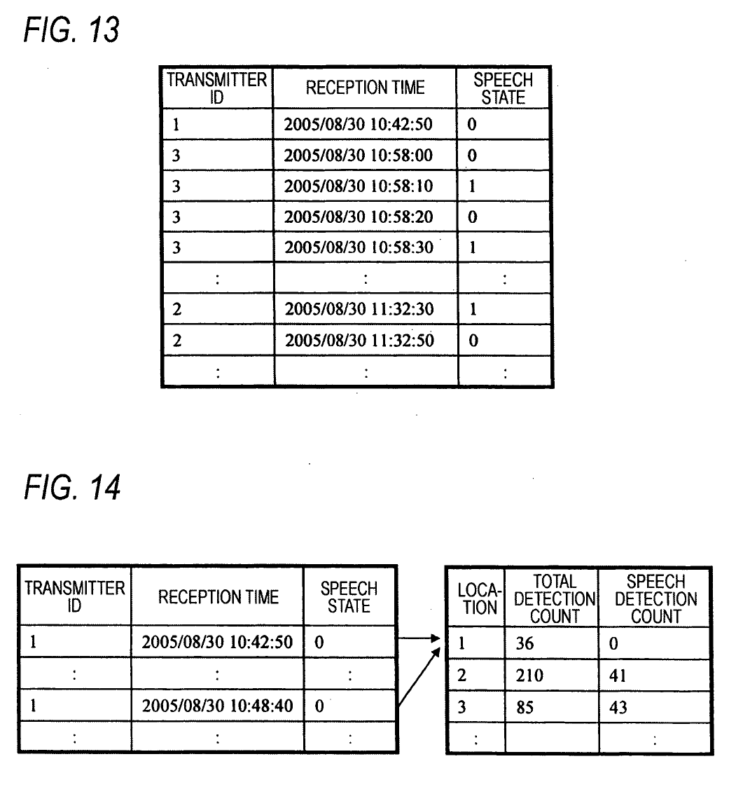

The record data structure of the second exemplary embodiment is as shown in FIG. 12. In the data structure of this example, the speech state is binary. Therefore, the storage capacity can be saved. Further, only the point in time at which the transmitter ID or the speech state changes may be recorded for furthermore saving the storage capacity, as shown in FIG. 13.

It is to be understood that the invention is not limited to the specific exemplary embodiments described above and that various changes and modifications of the invention can be made.

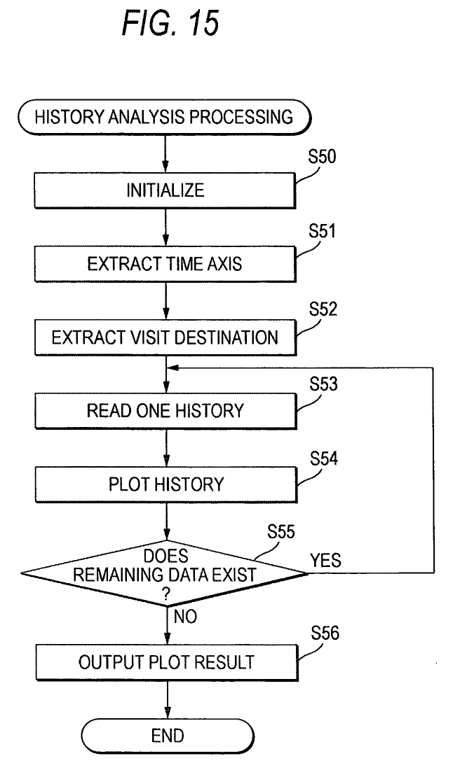

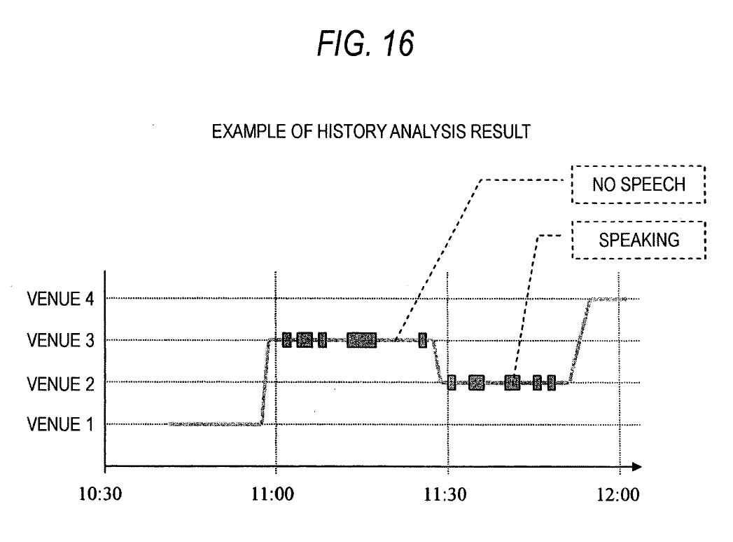

FIGS. 15 and 16 show a modified example for analyzing the traffic line of a receiver carrier as an example of history analysis processing.

In FIG. 15, first, initialization is executed (S50) and then, a time axis (time information) and visit destination (transmitter ID) are extracted (S51 and S52). The visit destination may be able to be selected in accordance with use purpose such as in the ID order or the visit order. Next, an individual history is read (S53) and speech state and non-speech state are plotted at each position matched with the time and the visit destination while the speech state and the non-speech state are differentiated (S54). The plotting is continued until the all history data are processed. When the all history data are processed, the plot result is output and the processing is completed (S55 and S56).

Accordingly, a diagram in which the speech state is incorporated into the motion of an individual can be created, for example, as shown in FIG. 16.

In the example described above, the time information count section 11 is typically a clock. However, since it is just required to have time information, not only a method of counting the current time with a real time clock, but also a mechanism for obtaining external time information, such as a wave clock may be used.

The receiver may include means for acquiring time information, for example, a clock and the time information may be contained in the history.

A signal may be transferred between the transmitter and the receiver by radio waves (feeble radio waves) or infrared radiation. In short, a signal may be able to be transmitted and received at the necessary timing using any desired wireless communication mechanism.

The analyzer 30 is separated from the receiver 20, but may be integrated with the receiver 20. The system may also be configured so that the analyzer 30 can be detached from the receiver main unit as required although the analyzer 30 is integral with the receiver 20 in the usual state.

The receiver may be a portable information machine such as a personal digital assistant or a part thereof, for example. In this case, the invention is embodied as a computer program. A microcomputer is installed in a portable receiver and the invention can also be embodied as a computer program of the microcomputer of the receiver.

The receiver may be formed like a badge or may be incorporated in any desired portable machine, for example, a mobile station of mobile communications.

What is claimed is:

1. An activity history record apparatus comprising:
a portable receiver that receives information, which contains position information and which is transmitted from a transmitter disposed at a predetermined position, wherein:
the receiver comprises
a reception section that receives the information;
a voice detection section that detects voice; and
a storage section that stores the position information extracted from the received information and voice-related information derived from the voice detected by the voice detection section, as a history.

2. The apparatus according to claim 1, further comprising:
an analysis section that analyzes the history stored in the storage section.

3. The apparatus according to claim 1, wherein the voice-related information is volume information.

4. The apparatus according to claim 1, wherein the voice-related information is binary information indicating presence or absence of voice.

5. The according to claim 1, wherein:
the history contains time information, and
the receiver comprises a timer section that outputs the time information.

6. The apparatus according to claim 1, wherein:
the history contains time information, and
the time information is contained in information received from an external apparatus.

7. The according to claim 6, wherein:
the external apparatus is the transmitter, and
the time information is contained in the transmitted information.

8. The apparatus according to claim 7, wherein:
the information transmitted from the transmitter is transmitted according to a predetermined time rule, and
the time information is recorded based on the predetermined time rule.

9. The apparatus according to claim 6, wherein the external apparatus is an apparatus that broadcasts the time information.

10. An activity history record apparatus comprising:
a transmission section disposed at a predetermined position, the transmission section that transmits information containing position information;
a portable reception section that receives the information, which contains the position information and which is transmitted from the transmission section;
a portable voice detection section integrated with the reception section, the voice detection section that detects voice; and
a storage section that stores the position information extracted from the received information and voice-related information derived from the voice detected by the voice detection section, as a history.

11. An activity history record apparatus comprising:
a transmitter disposed at a predetermined position, the transmitter that transmits information containing position information; and
a portable receiver that receives the information from the transmitter, wherein:
the receiver comprises:
a reception section that receives the information;
a voice detection section that detects voice;
a storage section that stores the position information extracted from the received information and voice-related information derived from the voice detected by the voice detection section, as a history; and
an analysis section that analyzes the history.

12. The apparatus according to claim 1, wherein the predetermined position is at least one facility selected from the group consisting of a conference room, a venue, a lounge and a meeting area.

13. An activity history record method comprising:
receiving information containing position information transmitted from a transmitter placed at a predetermined position;
detecting voice; and
storing the position information extracted from the information and voice-related information derived from the detected voice as a history.

14. A computer readable medium storing a program causing a computer to execute a process for recording an activity history, the process comprising:
receiving information containing position information transmitted from a transmitter placed at a predetermined position;
detecting voice; and
storing the position information extracted from the information and voice-related information derived from the detected voice as a history.

15. A computer data signal embodied in a carrier wave for enabling a computer to perform a process for recording an activity history, the process comprising:
receiving information containing position information transmitted from a transmitter placed at a predetermined position;
detecting voice; and
storing the position information extracted from the information and voice-related information derived from the detected voice as a history.
